(19) United States
(12) Patent Application Publication
(10) Pub. No.: US 2018/0150136 A1
(43) Pub. Date: May 31, 2018

(54) MOTOR VEHICLE OPERATOR CONTROL DEVICE WITH TOUCHSCREEN OPERATION

(71) Applicant: AUDI AG, Ingolstadt (DE)

(72) Inventors: Tahar BOUAZIZ, Ingolstadt (DE); Daniel LOTTES, Kelheim (DE); Onofrio DI FRANCO, Ditzingen (DE)

(73) Assignee: AUDI AG, Ingolstadt (DE)

(21) Appl. No.: 15/576,162

(22) PCT Filed: Aug. 25, 2016
(86) PCT No.: PCT/EP2016/070087

§ 371 Date: Nov. 21, 2017

(30) Foreign Application Priority Data
Sep. 11, 2015 (DE) 10 2015 011 650.9

(51) Int. Cl. G06F 3/01; B60K 35/00; G06F 3/0484; G06F 3/0488

(52) U.S. Cl. CPC G06F 3/016; B60K 35/00; G06F 3/04847; G06F 3/044; B60K 2350/1032; B60K 2350/901; G06F 3/04883

(57) ABSTRACT

A user interface for a motor vehicle is displayed on a touchscreen which detects at least one wiping movement. The user interface is generated by a control device controlling a vehicle device as a function of the at least one wiping movement. The user interface includes an operator control panel for setting a value of an operating parameter of the vehicle device. The control device activates the operator control panel as a function of a predetermined activation condition and sets the value in the operator control panel as a function of the at least one wiping movement when the operator control panel is activated. The control device assigns a part of the at least one wiping movement, detected outside the operator control panel, to the operator control panel and sets the value as a function of the part detected outside the operator control panel.

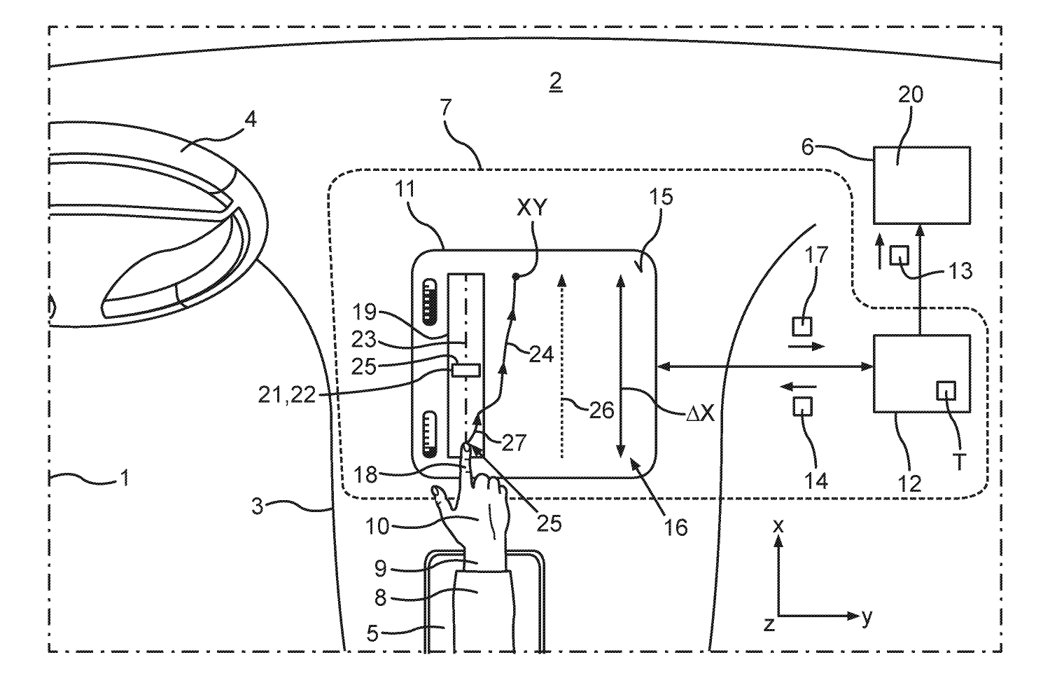

### CROSS REFERENCE TO RELATED APPLICATIONS

This application is the U.S. national stage of International Application No. PCT/EP2016/070087, filed Aug. 25, 2016, and claims the benefit thereof. The International Application claims the benefits of German Application No. 102015011650.9 filed on Sep. 11, 2015, both applications are incorporated by reference herein in their entirety.

### BACKGROUND

Described below is a control device for a motor vehicle. The control device has a touchscreen, which is configured for displaying a graphical user interface and for capturing a swiping movement. The user interface includes an operating field which can be operated by way of the swiping movement. The operating field can be, for example, a slider. It is possible by way of the operating field to set a value of an operating parameter of a vehicle device of the motor vehicle. A motor vehicle having the control device and a method for operating the control device are also described.

A user interface can be provided in a motor vehicle by way of a touchscreen. This pares down the use of mechanical operating elements, such as mechanical sliders. An operating element is realized on a touchscreen as an operating field within which the user must touch the touchscreen to change the switching state of the operating element.

A disadvantage in a user interface of a touchscreen is that the smooth surface of the touchscreen provides no tactile feedback to the user when operating an operating element. If the user operates a slider and another operating element that must be displaced or set by way of a swiping movement, a situation can occur in which the user slips off the operating field during the swiping movement and continues the swiping movement outside the operating field. In that case, the operating field is no longer controlled by the swiping movement. In the worst-case scenario, it may even be possible for an adjacent operating field to be changed or altered if the swiping movement continues into the adjacent operating field.

For this reason, users of touchscreens tend to look at the touchscreen when operating the user interface. However, that means that the user diverts his or her gaze away from the traffic. This can result in an accident risk in particular in the case of a driver.

### SUMMARY

The Compensation for the lack of tactile feedback of a touchscreen in a control device of a motor vehicle is provided.

The control device has a touchscreen for displaying a graphical user interface and for capturing at least one swiping movement. The touchscreen has a display area which can be pixel-based in a manner known per se. The display area is furthermore touch-sensitive, that is to say a sensor matrix captures a touch and/or an approaching movement toward an operating element by the user, for example by a finger, and signals the coordinates of the location of touch and/or of proximity. The sensor matrix can be provided, for example, on the basis of capacitive sensors.

The user interface has an operating field for setting a value of an operating parameter of a vehicle device of the motor vehicle. This operating field can be, for example, a slider or a bar graph or a rotary adjuster. The operating field is here represented or displayed in each case by way of a pixel graphic. Provided in the control device is furthermore a controller for generating the user interface and for controlling the vehicle device in dependence on the at least one swiping movement. Generating the user interface means that the controller generates graphics data which are displayed by the touchscreen. Generating the user interface furthermore means that the controller changes the display state of the operating field in dependence on the at least one swiping movement and, in dependence thereon, sets the value for the operating parameter of the vehicle device.

The controller is set up to activate the operating field in dependence on a predetermined activation condition and, once the operating field is activated, to set the value in the operating field in dependence on the at least one swiping movement. In other words, if the operating field is not activated, it does not react to the swiping movement. If the operating field is activated, the swiping movement is converted into a change in the value of the operating field. This value is then also the value that is set by the controller in the vehicle device as an operating parameter value.

In order to facilitate the operation of the operating field for the user such that he or she does not need to continuously observe the touchscreen, the controller is set up to assign, if the operating field is activated, a portion of the at least one swiping movement that is captured outside the operating field to the operating field, and to set the value of the operating field in dependence on the portion that is captured outside the operating field. In other words, the swiping movement can be performed partially or entirely outside the operating field. If the operating field is activated, the value of the operating field is still set by the controller in dependence on the swiping movement.

The advantage is that a user can perform the swiping movement partially or entirely even outside the operating field. For this reason, the user does not need to perform the swiping movement with particular precision.

Optional developments, from whose features additional advantages arise, are also described below.

In accordance with a development, the controller is set up to define in the operating field the value of the operating parameter in dependence on a linear component of the swiping movement along a predetermined adjusting axis of the operating field. In other words, the operating field is thus, for example, a linear slider or a bar graph. The linear component is here ascertained by projecting the swiping movement onto the adjusting axis. This gives the advantage that, even if a swiping movement is curved or wavy, the value is defined unambiguously and/or comprehensibly for the user.

Further developments relate to the activation of the operating field.

In accordance with a development, the controller is set up to activate the operating field upon at least one swiping movement if, as the activation condition, a starting point of the swiping movement lies within the operating field. This gives the advantage that it is possible to unambiguously select between a plurality of operating fields.

In accordance with a development, the controller is set up to activate the operating field upon at least one swiping movement if, as the activation condition, a starting point of the swiping movement lies outside the operating field and a starting direction of the swiping movement is aligned along a predetermined direction axis or in a predetermined direction. For example, it is thus possible for two operating fields to be provided which are adjustable in each case linearly along an adjusting axis, wherein in that case, the two adjusting axes can be aligned perpendicularly with respect to one another. If the swiping movement now begins parallel with respect to one of the adjusting axes, the operating field whose adjusting axis is aligned parallel with respect to the starting direction of the swiping movement can then be chosen. The advantage that results from this development is that an operating field is able to be activated even from outside the operating field.

Further developments relate to the linking of the swiping movement to the set value.

One development in this respect provides for the controller to be set up to set the value during at least one swiping movement in the operating field in dependence on an amount of movement of the swiping movement. In other words, starting from a starting value, the new value is set in dependence on the amount of movement. In other words, it is a relative value change that results from the amount of movement. This provides the advantage that, independently of a starting point of the swiping movement, the value is not changed erratically, but only proportionally with respect to the amount of movement.

In accordance with a development, in contrast, provision is made for the controller to be set up to set, during at least one swiping movement in the operating field, the value in dependence on a current point of touch of an input element that performs the swiping movement. The input element can be, for example, a finger or a wand. This development has the advantage that the user can use the swiping movement to set the desired new value particularly quickly by steering the point of touch to a corresponding location on the touchscreen.

One development relates to the deactivation of the operating field. In this development, the controller is set up to deactivate, after the activation of the operating field, the activated operating field after a predetermined time period has elapsed since the last captured swiping movement. This offers the advantage that the user can switch to the touchscreen and/or can again perform a swiping movement and as a result can set the value incrementally. The time period can here range, for example, from 1 second to 5 seconds.

In the motor vehicle, a vehicle device and a control device for the vehicle device are provided. The control device is coupled to the vehicle device for operating the same. In the motor vehicle, the advantage arises that a user, in particular a driver, does not need to continuously observe the touchscreen during the operation of the operating field of the user interface so that he or she performs the swiping movement continuously within the operating field using the finger or another input element.

Furthermore, in a method for operating a control device for a motor vehicle, a graphical user interface is generated on a touchscreen by a controller, and a vehicle device is controlled in dependence on at least one swiping movement captured by way of the touchscreen. The user interface has, in the manner described, an operating field for setting a value of an operating parameter of the vehicle device. The operating field can in this case for example be a slider, a bar graph, or a rotary adjuster. The controller is used to activate the operating field in dependence on a predetermined activation condition and, once the operating field is activated, to set the value of the operating field, i.e. the value of the operating parameter to be set in the vehicle device, in dependence on the at least one swiping movement. Here, if the operating field is activated, a portion of the at least one swiping movement that is captured outside the operating field is assigned to the operating field by the controller, and the value is set in dependence on the portion that is captured outside the operating field. This, of course, also means that a portion of the swiping movement that is captured within the operating field is used for setting the value.

The motor vehicle may be a car, in particular a passenger car.

Developments of the method include features, as have already been described in connection with the developments of the control device. For this reason, the corresponding developments of the method will not be described again here.

### BRIEF DESCRIPTION OF THE DRAWINGS

These and other aspects and advantages will become more apparent and more readily appreciated from the following description of the exemplary embodiment, taken in conjunction with the accompanying drawings of which:

The only FIGURE is a schematic illustration of an embodiment of the motor vehicle.

### DETAILED DESCRIPTION OF THE PREFERRED EMBODIMENT

The exemplary embodiment will be explained below. In the exemplary embodiment, the described components of the embodiment are in each case individual features which should be considered independently of one another, which also develop the method independently from one another in each case, and which should therefore also be considered to be part of the invention individually or in a different combination than the one shown. The described embodiment is furthermore also able to be supplemented by further features to those already described.

The FIGURE shows a motor vehicle 1, which can be for example a car, in particular a passenger car. The FIGURE shows a motor vehicle 1, which can be for example a car, in particular a passenger car. It shows a plan view of a vehicle interior 2 of the motor vehicle 1. For better orientation, a direction of a vehicle longitudinal axis X, of a vehicle lateral axis Y, and of a vehicle height axis Z are shown. The height axis Z is aligned perpendicular with respect to the drawing plane of the FIGURE. Shown are a center console 3, a steering wheel 4, a support element 5, a vehicle device 6, and a control device 7 for the vehicle device 6. The support element 5 is arranged above or over the center console 3. The support element 5 is an armrest on which a driver 8 can rest his or her forearm 9 and/or hand 10, while the driver 8 is seated in a driving seat (not illustrated). The driver 8 represents a user of the control device 7.

The control device 7 can be used by the driver 8 to operate the vehicle device 6. The vehicle device 6 can be, by way of example, an air-conditioning system for the vehicle interior 6. The vehicle device 6 can, for example, also be an infotainment system (information entertainment system) of the motor vehicle 1.

The control device 7 has a touchscreen 11 and a controller 12. The controller 12 generates a control signal 13 for the vehicle device 6 in dependence on an operation of the touchscreen 11 by the user 8.

To this end, the controller 12 can generate graphics data 14, by way of which a graphical user interface 16 for the vehicle device 6 can be displayed or represented on a display area 15 of the touchscreen 11. The display area 15 is touch-sensitive. If the display area 15 is touched, the touchscreen 11 generates touch data 17, which describe for example a current touch coordinate at which touching of the display area 15 was sensed or detected. The driver 8 can touch it by way of a finger 18 of the hand 10. The finger 18 thus represents an input element. The touch-sensitive display area can be configured, for example, on the basis of a sensor matrix. The sensors of the sensor matrix can, for example, each be in the form of a capacitive sensor.

The user interface 16 has in particular an operating field 19. Further operating fields are not illustrated for the sake of clarity. The operating field 19 can be used to set an operating parameter 20 in the vehicle device 6. A current value 21 of the operating parameter 20 can be illustrated or displayed on the operating field 19 for example by a respective display element 22. The operating parameter 20 can be, for example, a predetermined temperature for an air-conditioning system or the blower performance of a blower of the air-conditioning system. The display element 21 can be, for example, in each case a bar graph or a slider.

The display element 22 can be displaced on the operating field 19 along a predetermined adjusting axis 23. As a result of this, the current value 21 is accordingly changed or adjusted. By way of example, the adjusting axis 23 (as shown) can be arranged such that it is parallel with respect to the vehicle longitudinal axis X. The adjusting axis 23 can also be aligned parallel with respect to the vehicle lateral axis Y.

The corresponding setting of the value 21 in the operating parameter 20 is effected by the controller 12 by way of the control signal 13. The controller 12 can to this end be realized, for example, on the basis of a microcontroller or a microprocessor.

To adjust or set the value 21, the driver 8 touches the touch-sensitive display area 15 with the finger 18 and performs a swiping movement 24. In other words, while the finger 18 maintains contact with the display area 15, he or she performs a change in position or a movement trajectory.

The swiping movement 24 has a starting point 25, at which the swiping movement 29 begins and/or at which the driver 8 placed the finger 18 on the display area 15.

The starting point 25 and the swiping movement 24 are detected by the controller 12 on the basis of the touch data 17. The operating field 19 is initially deactivated. The controller 12 here determines whether the operating field 19 should be activated.

A plurality of variants can be provided here.

One variant makes provision for a determination to be carried out, in dependence on a position or location of the starting point 25 on the display area 15, as to whether the operating field 19 is activated. In the example illustrated in the FIGURE, the starting point 25 lies within the operating field 19. For this reason, the operating field 19 is activated by the controller 12 and operated during the swiping movement 29. Here, a linear component 26 can be ascertained for determining the value 21. The value change in the value 21 of the operating field 19 is here set in dependence on the linear component 26 of the swiping movement 24. The linear component 26 is the component of the swiping movement 24 that results from a projection of the trajectory of the swiping movement 24 onto the adjusting axis 23 of the operating field 19. The linear component 26 correspondingly defines the value 21 of the operating parameter 20 by way of the operating field 19. Accordingly, the display element 22 is set or displaced to the respectively newly set value 21.

One variant makes provision for an initial movement direction or starting direction 27 of the swiping movement 24 to be ascertained by the controller 12 independently of a location of the starting point 25, and for the operating field 19 to be selected in dependence on the starting direction 27. In the illustrated example, the starting direction 27 is aligned parallel, or at least predominantly parallel, with respect to the adjusting axis 23 of the operating element 19. The operating element 19 is accordingly activated by the controller 12 and operated during the swiping movement 24.

As illustrated in the FIGURE, all three variants allow the driver 8 to be able to perform his or her swiping movement 24 with the finger 18 even outside the operating field 19 and that the operating field 19 is still set in accordance with the swiping movement 24.

By arranging adjusting axes at a right angle, an orthogonally independent operation is achieved in the described manner.

The operation or setting/adjustment of a variable (e.g. blower, air-conditioning) is thus continued (tolerance condition), even though the illustrated regulator was touched e.g. initially only by way of a touch gesture, without the movement of the finger remaining on the bar of the regulator, but being continued at another location on the touchscreen.

The advantage is intuitive operation, without distracting the driver during his or her journey, because there is no longer a need to make sure that the regulator is touched precisely over the entire setting procedure.

The implementation of this function that, at the beginning of a parameter adjustment/setting, setting can be continued at any location on the touchscreen is possible in the described variants.

One modification is to omit the first touching of the area from the start and to implement fixed gestures, such as swiping to the left/right (reducing/increasing the blower speed) and down/up (reducing/increasing the air-conditioning temperature). This improves blind operation.

With respect to the set value 21, provision may on the one hand be made for the value 21 to be evaluated or taken into consideration or used by evaluating the relative movement of the finger 18 during the swiping movement 24. To this end, an amount of movement ΔX of the swiping movement 24 along the adjusting axis 23 is evaluated. In other words, a respective length of the linear component 26 is evaluated to the effect that this amount of movement ΔX defines the change in the starting value to the end value, i.e. to the new value 21, in the operating field 19.

Provision can alternatively be made for the value 21 to be defined in dependence on an end coordinate XY of the swiping movement 24. In other words, the value 21 is in each case defined absolutely in dependence on the current touch position of the finger 18 on the display area 15.

Provision can be made for the activated operating field 19 to remain activated, after the operating field 19 has been activated, for a time period T after the swiping movement 24 has terminated, when the user has removed the finger 18 from the display area 15. As a result, the user can still perform a correction independently of a location of touch on the display area 15. The time period T can be monitored by the controller 12.

Overall, the example shows how a tolerance operation or continued operation can be provided in the case of a departure from the operating region (regulator, bar) of the corresponding operating element (e.g. air-conditioning regulator in the touchscreen).

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-10. (canceled)

11. A control device for a motor vehicle, comprising:
a touchscreen configured to display a graphical user interface and to capture at least one swiping movement; and
a controller configured to generate the graphical user interface and to control a vehicle device in dependence on the at least one swiping movement, the graphical user interface having an operating field for setting a value of an operating parameter of the vehicle device, the controller further configured to activate the operating field in dependence on a predetermined activation condition and, once the operating field is activated, to set the value in the operating field in dependence on the at least one swiping movement, including to assign, when the operating field is activated, a portion of the at least one swiping movement captured outside the operating field to the operating field, and to set the value in dependence on the portion that is captured outside the operating field.

12. The control device as claimed in claim 11, wherein the controller is further configured to define in the operating field the value in dependence on a linear component of the swiping movement along a predetermined adjusting axis of the operating field and to ascertain the linear component by projecting the swiping movement onto the adjusting axis.

13. The control device as claimed in claim 11, wherein the controller is further configured to activate the operating field upon the at least one swiping movement when, as the activation condition, a starting point of the swiping movement lies within the operating field.

14. The control device as claimed in claim 11, wherein the controller is further configured to activate the operating field upon the at least one swiping movement when, as the activation condition, a starting point of the swiping movement lies outside the operating field and a starting direction of the swiping movement is one of aligned along a predetermined direction axis and in a predetermined direction.

15. The control device as claimed in claim 11, wherein the controller is further configured to set, during at least one swiping movement in the operating field, the value in dependence on an amount of movement of the swiping movement.

16. The control device as claimed in claim 11, wherein the controller is further configured to set, during at least one swiping movement in the operating field, the value in dependence on a current point of touch of an input element that performs the swiping movement.

17. The control device as claimed in claim 11, wherein the controller is further configured to deactivate, after the activation of the operating field, the activated operating field after a predetermined time period has elapsed since a last captured swiping movement.

18. The control device as claimed in claim 11, wherein the operating field is one of a slider, a bar graph and a rotary adjuster.

19. A motor vehicle, comprising:
a vehicle device;
a touchscreen configured to display a graphical user interface and to capture at least one swiping movement, the graphical user interface having an operating field for setting a value of an operating parameter of the vehicle device; and
a controller, coupled to the vehicle device, configured to generate the graphical user interface, to control the vehicle device in dependence on the at least one swiping movement, to activate the operating field in dependence on a predetermined activation condition and, once the operating field is activated, to set the value in the operating field in dependence on the at least one swiping movement, including to assign, when the operating field is activated, a portion of the at least one swiping movement captured outside the operating field to the operating field, and to set the value in dependence on the portion that is captured outside the operating field.

20. The motor vehicle as claimed in claim 19, wherein the controller is further configured to define in the operating field the value in dependence on a linear component of the swiping movement along a predetermined adjusting axis of the operating field and to ascertain the linear component by projecting the swiping movement onto the adjusting axis.

21. The motor vehicle as claimed in claim 19, wherein the controller is further configured to activate the operating field upon the at least one swiping movement when, as the activation condition, a starting point of the swiping movement lies within the operating field.

22. The motor vehicle as claimed in claim 19, wherein the controller is further configured to activate the operating field upon the at least one swiping movement when, as the activation condition, a starting point of the swiping movement lies outside the operating field and a starting direction of the swiping movement is one of aligned along a predetermined direction axis and in a predetermined direction.

23. A method for operating a control device for a motor vehicle, comprising:
generating, by a controller, a graphical user interface on a touchscreen, the graphical user interface having an operating field for setting a value of an operating parameter of a vehicle device;
activating, by the controller, the operating field in dependence on a predetermined activation condition;
capturing, by the touchscreen, at least one swiping movement;
setting, by the controller when the operating field is activated, the value in the operating field in dependence on the at least one swiping movement;
assigning, by the controller, when the operating field is activated, a portion of the at least one swiping movement that is captured outside the operating field to the operating field;
setting, by the controller, the value in dependence on the portion that is captured outside the operating field; and
controlling the vehicle device in dependence on the at least one swiping movement captured by the touchscreen.

24. The method as claimed in claim 23, further comprising:
defining, by the controller, the value in the operating field in dependence on a linear component of the swiping movement along a predetermined adjusting axis of the operating field; and
ascertaining, by the controller, the linear component by projecting the swiping movement onto the adjusting axis.

25. The method as claimed in claim 23, wherein the activation condition is the at least one swiping movement having a starting point within the operating field.

26. The method as claimed in claim 23, wherein the activation condition is the at least one swiping movement having a starting point outside the operating field and a starting direction one of in a predetermined direction and aligned along a predetermined direction axis.

27. The method as claimed in claim 23, further comprising setting, by the controller during at least one swiping movement in the operating field, the value in dependence on an amount of movement of the swiping movement.

28. The method as claimed in claim 23, further comprising setting, by the controller during at least one swiping movement in the operating field, the value in dependence on a point of touch of an input element that performs the swiping movement.

29. The method as claimed in claim 23, further comprising deactivating, by the controller, the activated operating field after a predetermined time period has elapsed since a last captured swiping movement.

30. The method as claimed in claim 23, wherein the operating field is one of a slider, a bar graph and a rotary adjuster.
